(19) United States
(12) Patent Application Publication
(10) Pub. No.: US 2019/0255734 A1
(43) Pub. Date: Aug. 22, 2019

(54) METHOD AND MOLD FOR RETAINING WALL CORNER AND COLUMN BLOCKS

(71) Applicant: Western Interlock, Inc., Rickreall, OR (US)

(72) Inventor: Wyatt Pegg, Rickreall, OR (US)

(21) Appl. No.: 15/902,783

(22) Filed: Feb. 22, 2018

(51) Int. Cl. B28B 7/18; B28B 7/10; B28B 7/24

(52) U.S. Cl. CPC B28B 7/183; E02D 29/025; B28B 7/24; B28B 7/10

(57) ABSTRACT

A method and mold assembly for forming a dry cast concrete corner blocks having non-parallel front and rear faces and non-parallel end faces, with a hollow central core in the blocks. The corner blocks can be used to build a square or irregular corner in a retaining wall, and can be used to build columns or pillars in the wall, without having to cut the corner blocks. Fill material may be poured into aligned cores in the stacked corner blocks which form the wall corner or column, to stabilize the corner blocks.

### FIELD OF THE INVENTION

A mold assembly is provided for forming non-rectangular, left and right corner blocks for constructing corners, columns, and pillars in a retaining wall. Opposing faces of the corner block are not parallel to one another, thereby permitting non-square corners to be formed in the wall without cutting the corner blocks.

### BACKGROUND OF THE INVENTION

Concrete blocks are often used to build retaining walls of various sizes and shapes. The walls often have corners and/or columns. Conventional blocks used for the corners and columns are square or rectangular, and often require cutting so that adjacent blocks can fit together to form the corner or the column. Such cutting adds time and cost to the construction of the wall. Also, some corner blocks used in wall construction are solid, and thus heavy. The solid blocks also prevent adjacent layers or tiers from being tied together by aggragate fill. Furthermore, the square rectangular blocks are difficult to form into irregular, non-perpendicular angles without cutting the block.

Therefore, there is a need in the industry for an improved corner block, corner block mold, and method of constructing corners and columns in a retaining wall.

Accordingly, a primary objective of the present invention is a provision of a method and mold for forming dry cast concrete corner blocks for use in building corners and columns or pillars in retaining walls.

Another objective of the present invention is the provision of a mold for creating a corner block with non-parallel front and rear surfaces and non-parallel end surfaces for use in a retaining wall.

A further objective of the present invention is a provision of a method for building a retaining wall corner or column using corner blocks having at least one corner which is not square.

Still another objective of the present invention is a provision of a dry cast concrete corner block for use in constructing corners and columns in a retaining wall.

These and other objectives have become apparent from the following description of the invention.

### SUMMARY OF THE INVENTION

A mold for forming dry cast concrete corner blocks used in building a retaining wall corner or column comprises four faces, with opposing faces being non-parallel to one another, and at least two adjacent faces being non-perpendicular to one another, so as to yield a non-rectangular corner block. The mold forms a plurality of corner blocks simultaneously, and with a hollow core in each block. The corner blocks are formed in left and right mirror image pairs which can then be used for the wall corners or columns, which can be built with irregular, non-square angles. In the molding process, after the concrete has cured to form each corner block, the mold is raised while the tamper head remains stationery such that the block is ejected out of the bottom of the mold onto a base plate or pallet or floor.

### BRIEF DESCRIPTION OF THE DRAWINGS

FIG. 1 is a perspective view of the corner block mold assembly according to the present invention.

FIG. 2 is a top plan view of the mold assembly.

FIG. 3 is a side elevation view of the mold assembly.

FIG. 4 is an end elevation view of the mold assembly.

FIG. 5 is a side elevation view of the tamper head.

FIG. 6 is a bottom plan view of the tamper head.

FIG. 7 is an exploded view of the mold and tamper head.

FIG. 8 is a perspective view of a corner block formed by the mold assembly, and having a flat front face.

FIG. 8A is a perspective view of a second embodiment for a corner block formed by the mold assembly and having a front face with multiple planes.

FIG. 9 is an elevation view of one end of the block shown in FIG. 8.

FIG. 10 is an end elevation view of the opposite end of the block, from FIG. 9.

FIG. 11 is a front elevation view of the corner block shown in FIG. 8.

FIG. 12 is a rear elevation view of the corner block shown in FIG. 8.

FIG. 13 is a top plan view of the corner block shown in FIG. 8.

FIG. 13A is a top plan view of an alternative corner block having a multiple plane front face.

FIG. 14 is a bottom plan view of the corner block shown in FIG. 8.

FIG. 15 shows a retaining wall having a corner built with the corner blocks formed by the mold assembly.

FIG. 16 shows a retaining wall having a column or pillar built with the corner blocks formed by the mold assembly.

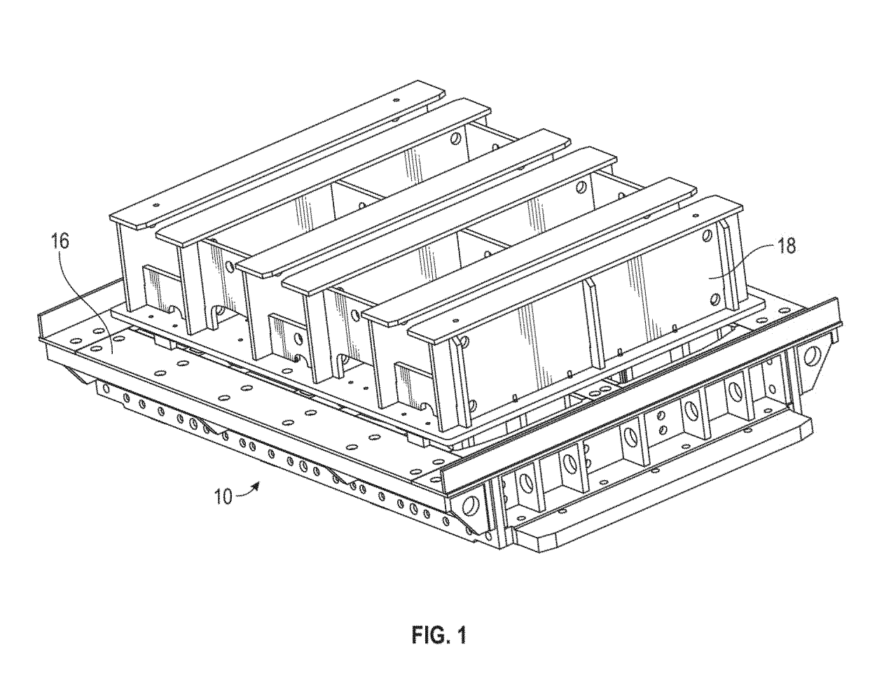

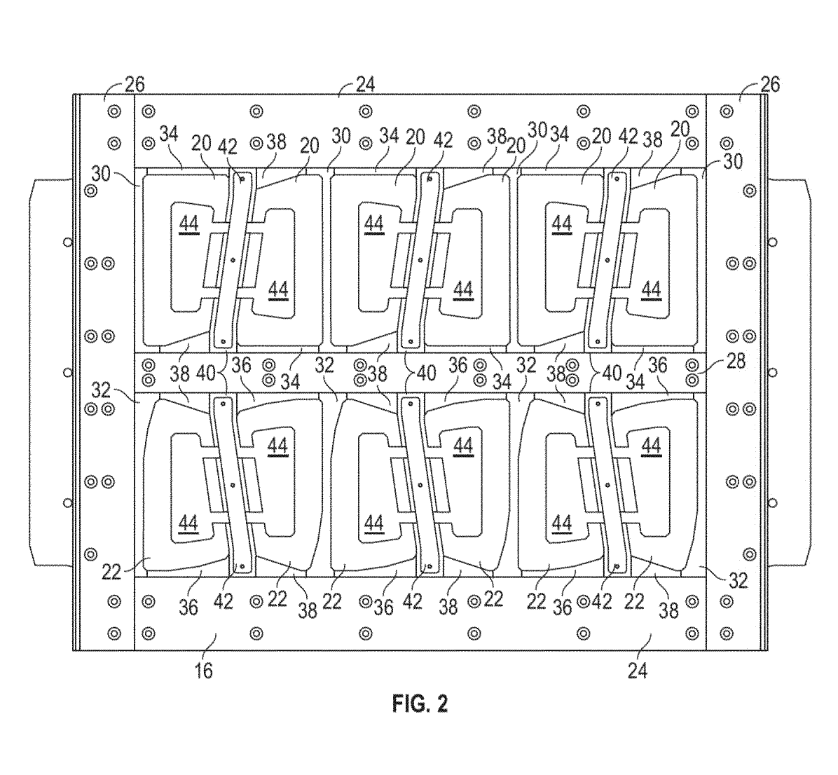

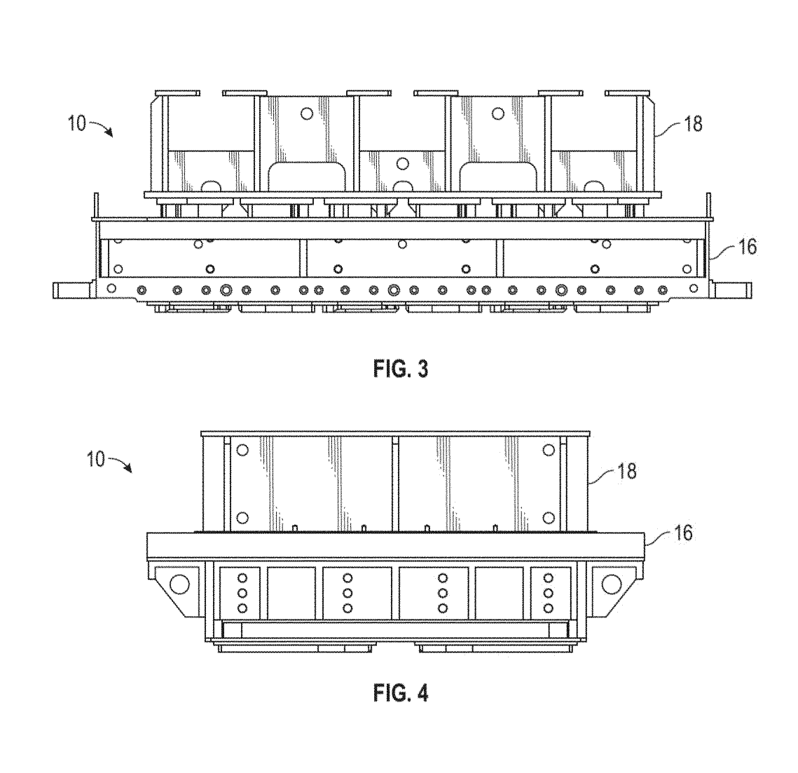

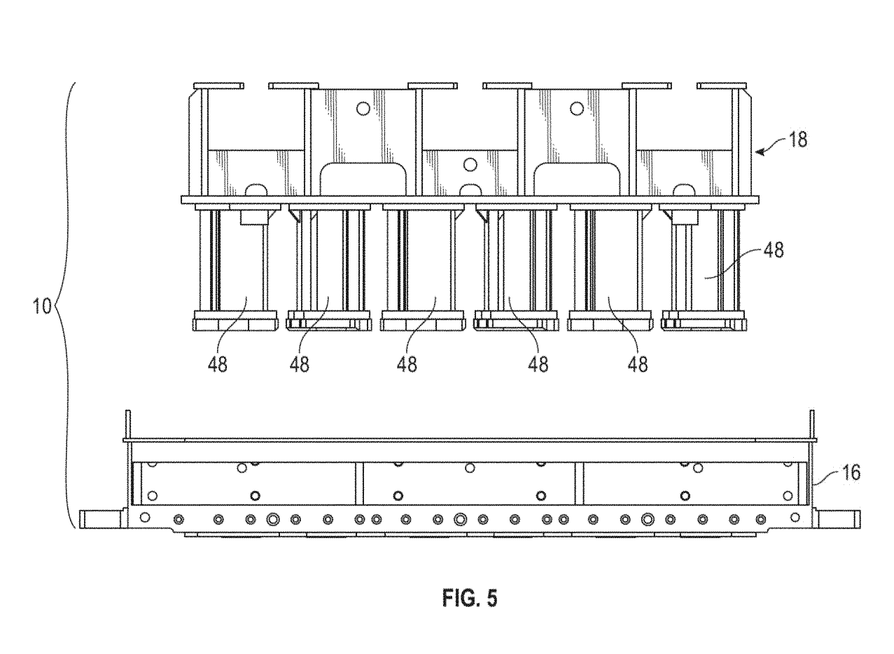

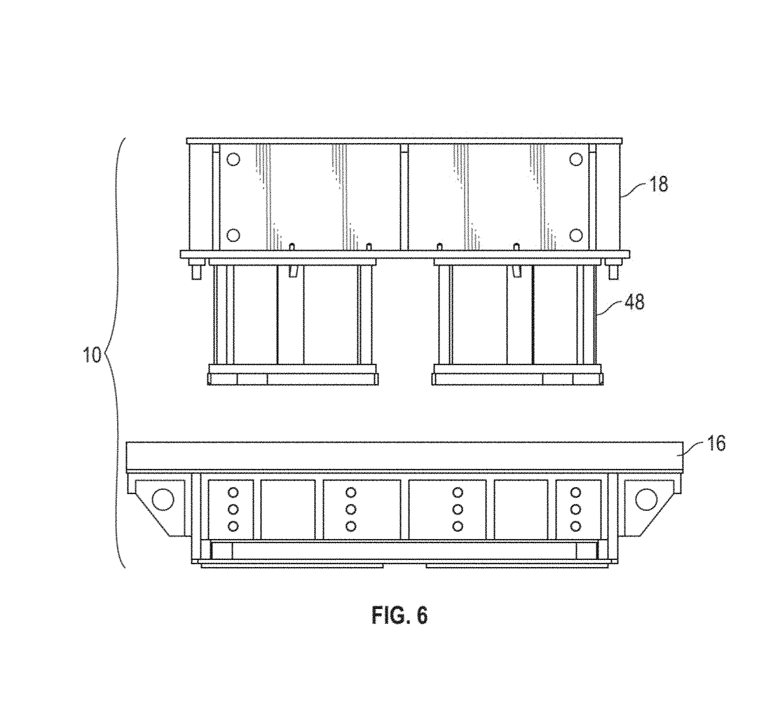

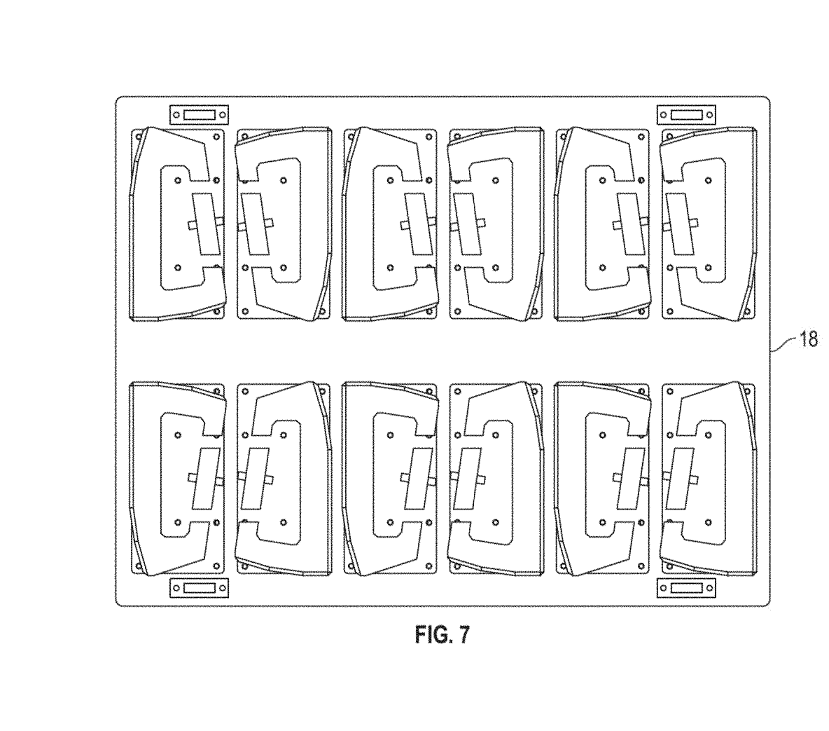

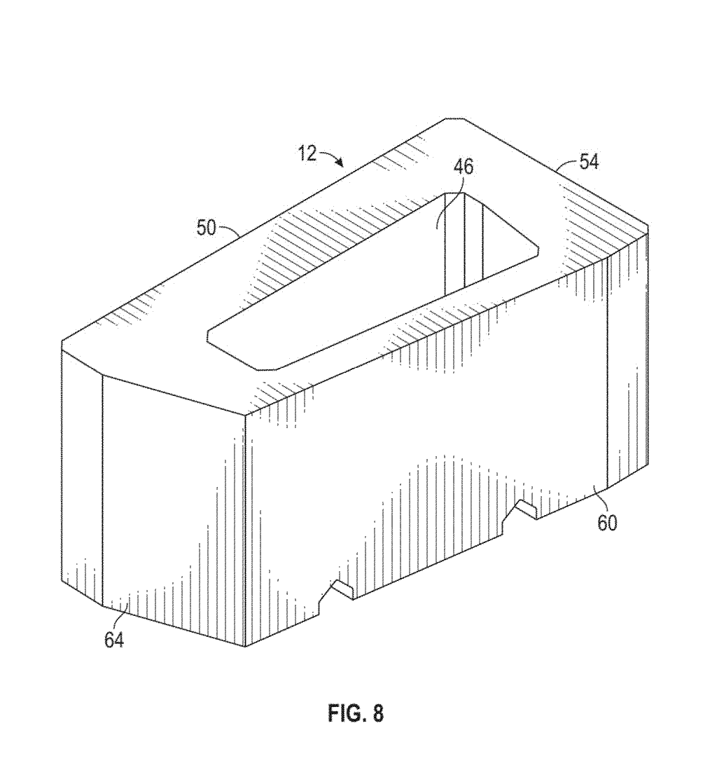

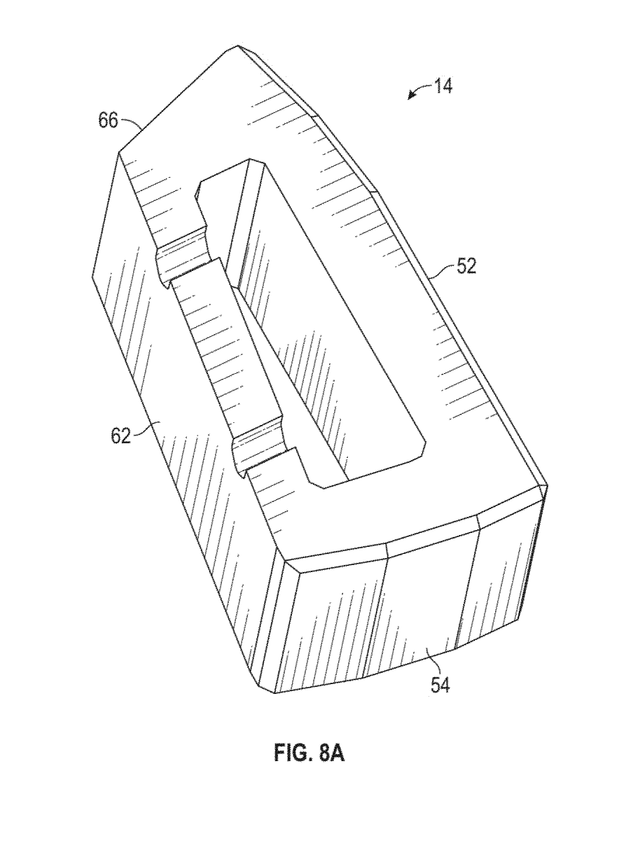

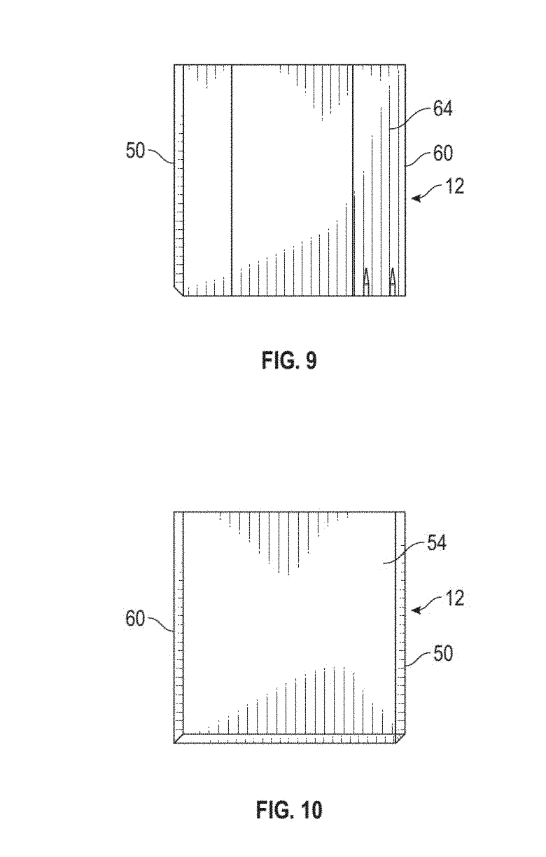

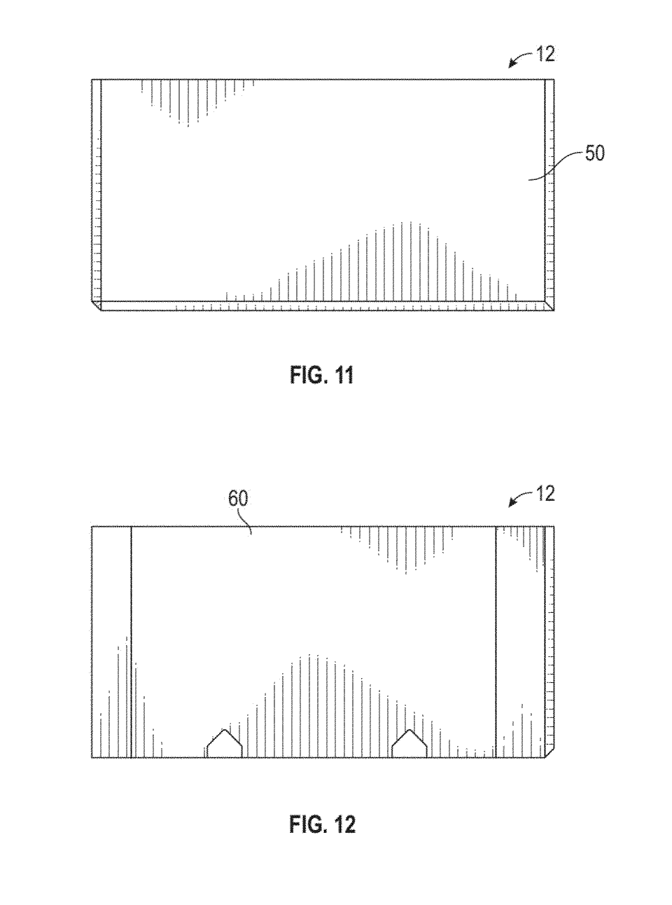

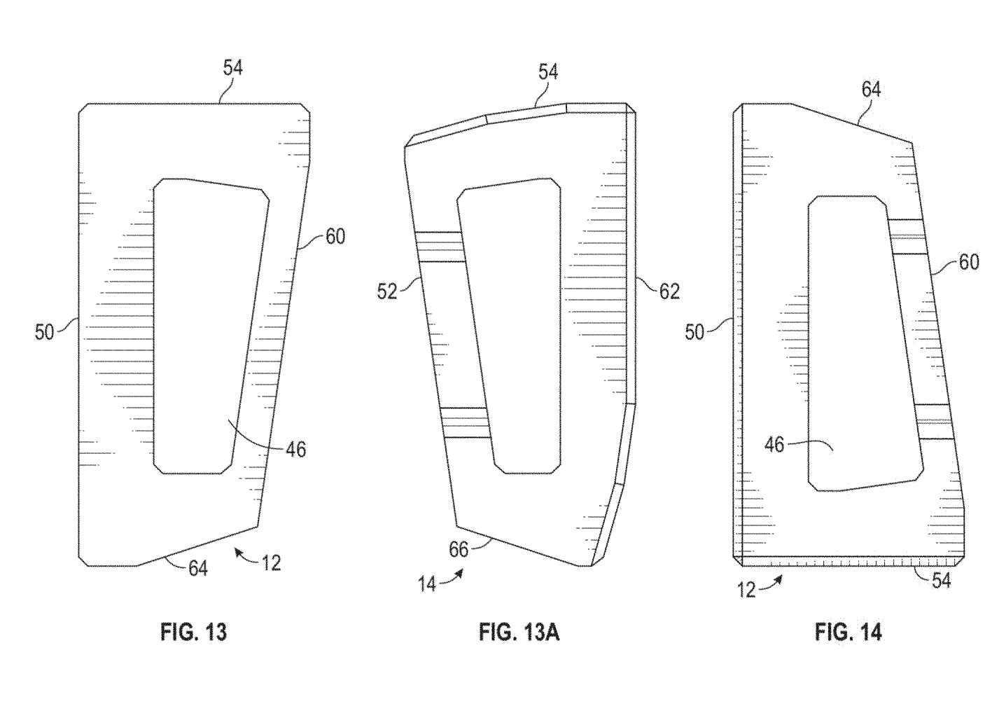

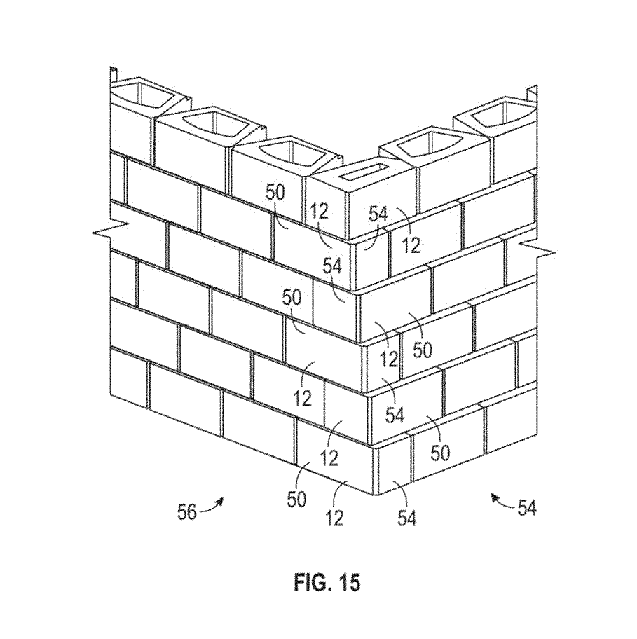

### DETAILED DESCRIPTION OF THE DRAWINGS

The mold assembly of the present invention is generally designated by the reference numeral 10, and is designed to form dry cast concrete corner blocks 12 and 14. The primary difference between the blocks 12, 14 is the front face of each block. Block 12 has a flat front face, while block 14 has a multi-planar front face.

The mold assembly generally includes a mold box 16 and a tamper head 18. The mold box 16 has four walls which form an open top and an open bottom. The box 16 has internal structural components which create cavities 20, 22 for forming the blocks 12, 14. The box 16 includes side deck plates 24 and end deck plates 26. A center bar or deck plate 28 extends between the end deck plates 26, and substantially flush with the upper surfaces of the deck plates 24, 26.

A plurality of shoe molds 30, 32, 34, and 36 are mounted in the box 16. The shoe molds 30 being a single plane flat surface for the blocks 12, while the show molds 32 provide a multi-plane front surface for the box 14. The shoe molds 34 provide a single plane surface for one end of a block 12, while the shoe molds 36 provide a multi plane surface for one end of the block 14. The end shoe molds 38 are used for the opposite ends of both blocks 12, 14. The mold block 16 also includes an inside web 40 with a web deck plate 42. Collectively, the shoe molds and inside webs form the cavities 20, 22. The cavities 20 are arranged so as to form left and right versions of the block 12, which are mirror images of one another. Similarly, the cavities 22 are configured to form left and right mirror images of the block 14. It is understood that the mold box 16 can be used for making both the blocks 12 and 14, only blocks 12, or only blocks 14, as desired. The shoes 30, 32 can be interchanged with one another as can the shoes 34, 36.

A core plug 44 is provided for each cavity 20, 22 so as to form a hollow, central core 46 in each block 12, 14. If a solid block is desired, the core plugs 44 may be removed.

The tamper head 18 is adapted to compress the concrete in the cavities 22, 24. The tamper head 18 is formed with plurality of legs 48, each having a lower surface configured to fit in close tolerance with the cavities 20, 22.

The mold process begins by determining which blocks 12, 14 are desired, and then installing the appropriate shoes 30-38 in the mold box 16, along with the inside webs 40. Once the mold box 16 is fully assembled, the box is positioned on a pallet or plate (not shown) or on a smooth floor so that the dry cast concrete can be introduced into the cavities 20, 22 of the mold box 16. Then, the tamper head 18 is lowered into contact with the concrete to compact the concrete in the cavities 20, 22. Preferably, the tamper head 18 is vibrated during the compaction time. The base pallet or plate may also be vibrated during compaction, such as by a vibrator positioned beneath the plate or pallet. Once the compaction is complete, the mold box 16 is raised, while the taper head 18 remains stationary so as to push the molded blocks 12, 14 out of the open bottom of the box. The base plate or pallet with the blocks 12, 14 thereon can be moved and replaced with an empty base plate or pallet, so that the molding process can be repeated for a new set of blocks.

If desired, the molded blocks 12, 14 can be tumbled to roughen the block, and particularly the front face to provide a more textured appearance to the front walls 50, 52 and end walls 54, 56 of the blocks 12, 14, respectively.

While the drawings show the mold assembly 10 as having 12 cavities 20, 22, it is understood that more or less cavities may be provided in the mold assembly 10. Also, the perimeter shape of the cavities 20, 22 can be modified from that shown in the drawings, without departing from the scope of the present invention.

The mold box 16 forms the blocks 12, 14 such that the front faces or walls 50, 52 are not parallel with the rear walls 60, 62. Likewise, the opposite end walls 54, 64 of the block 12 are not parallel to one another, nor are the end walls 56, 66 of the block 14 parallel to one another.

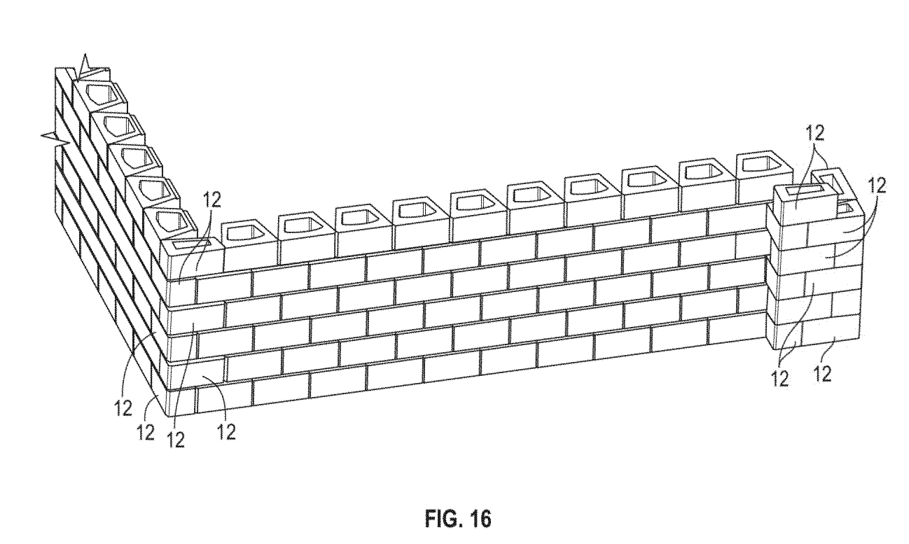

Preferably, the front wall or face 50 and end wall 54 of the block 12 are formed perpendicular to one another. This square corner between the walls 50, 54 allows a right-angle corner to be formed in a retaining wall as shown in FIG. 15. Alternatively, an irregular, non-perpendicular corner can be formed in the retaining wall due to the non-square angular relationship between the front faces 50, 52 and the end wall 64, 66. Similarly, column or pillars 70 can be formed in the retaining wall as shown in FIG. 16 using the blocks 12 or 14. The wall corners and columns or pillars can be built without cutting the blocks 12, 14. Furthermore, the hollow cores 46 of the blocks 12, 14 partially overlap one another in the wall corner or column, such that aggregate, gravel, or concrete can be used to fill the aligned cores and thereby stabilize the corner or column.

The dry cast concrete used in molding the blocks 12, 14 may be a single homogenous color, or may comprise multiple colors. Preferably, an initial batch of dry cast concrete is produced in a large planetary mixer, and is then emptied into multiple hoppers beneath the mixer. Each hopper can hold a different color concrete or the same color concrete. The concrete from each hopper is then introduced into a production machine hopper using a concrete feeding belt. Color blends may be created by layering the different color concrete from multiple hoppers into the production machine hopper using timers for the multiple hoppers beneath the mixer. The concrete is then transferred from the production machine hopper into a movable feeding box beneath the production machine hopper. The feed box then can be moved over the mold assembly 10 so that the single or multi-colored concrete is filled into the mold cavities 20, 22, as described above.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

1. A method of forming a dry cast concrete corner block, comprising:
pouring concrete into a mold having an open top, an open bottom, and having a cavity defining a perimeter of the block;
forming first and second cavity walls adjacent and perpendicular to one;
forming third and fourth cavity walls adjacent and non-perpendicular to one another and non-parallel to the first and second cavity walls;
filling the cavity with concrete;
lowering a tamper head onto the concrete in the mold to compact the concrete;
allowing the concrete to cure to form the corner block;
raising the mold while retaining the tamper head stationary such that the corner block is ejected out of the bottom of the mold.

2. The method of claim 1 further comprising tumbling the ejected corner block to mechanically roughen the block.

3. The method of claim 1 wherein the concrete contains at least three color variations.

4. The method of claim 1 further comprising forming a hollow center core in the block.

5. A mold assembly for forming a dry cast concrete block, comprising:
a mold form and having first, second, third and fourth walls defining a cavity, an open top, and an open bottom;
the first and second walls having adjacent ends and being perpendicular to one another;
the third and fourth walls having adjacent ends and being non-perpendicular to one another;
the first and third walls being non-parallel to one another;
the second and fourth walls being non-parallel to one another; and
a tamper head adapted to fit within the first, second, third and fourth walls.

6. The mold assembly of claim 5 wherein the mold form has a central core to create a vertical opening in the block.

7. The mold assembly of claim 5 wherein the third wall is angled inwardly relative to the second wall.

8. The mold assembly of claim 5 wherein the fourth wall is angled inwardly relative to the first wall.

9. The mold assembly of claim 5 wherein the third and fourth walls are joined at an obtuse angle.

10. A molded concrete corner block for use in building a retaining wall, comprising:
a front first face;
an end second face;
a rear third face;
an end fourth face;
the first and second faces being perpendicular to one another for forming a square corner in the retaining wall;
the third and fourth faces being non-perpendicular to one another;
the first and third faces being non-parallel to one another; and
the second and fourth faces being non-parallel to one another.

11. The corner block of claim 10 wherein the first face is substantially a single plane.

12. The corner block of claim 11 wherein the second face is substantially a single plane.

13. The corner block of claim 11 wherein the front face has multiple planes.

14. The corner block of claim 10 wherein the fourth face is angled inwardly relative to the first face.

15. The corner block of claim 10 wherein the third face is angled inwardly relative to the second face.

16. The corner block of claim 10 wherein the first and second faces are roughened by tumbling the block.

17. The corner block of claim 10 further comprising at least three colors in the first and second faces.

18. The corner block of claim 10 wherein the block is formed by a dry cast process.

19. A retaining wall block, comprising:
a front face, a rear face, and opposite end faces; and
the front face and one of the end faces form a vertical square corner for the block; and
wherein the rear face is not perpendicular to either end face.

20. The retaining wall block of claim 19 wherein the front face is perpendicular to one of the end faces.

21. (canceled)

22. The retaining wall block of claim 19 wherein none of the faces being parallel to one another.

23. The retaining wall block of claim 19 wherein the block is formed by dry casting.

24. The retaining wall block of claim 19 wherein the front face has at least three colors.

25. The retaining wall block of claim 19 wherein the front face is a single plane.

26. The retaining wall block of claim 19 wherein the front face has multiple planes.
